(19) United States
(12) Patent Application Publication
(10) Pub. No.: US 2011/0167479 A1
(43) Pub. Date: Jul. 7, 2011

(54) ENFORCEMENT OF POLICIES ON CONTEXT-BASED AUTHORIZATION

(75) Inventor: Stephane H. Maes, Fremont, CA (US)

(73) Assignee: Oracle International Corporation, Redwood Shores, CA (US)

(21) Appl. No.: 12/986,435

(22) Filed: Jan. 7, 2011

Related U.S. Application Data
(60) Provisional application No. 61/293,158, filed on Jan. 7, 2010.

(51) Int. Cl. H04L 9/32; G06F 21/00

(52) U.S. Cl. 726/4

(57) ABSTRACT

Embodiments of the invention provide methods and systems for enforcing usage/context-based authorization. The method may include generating an authorization context for access to a resource. The access may include a first set of access parameters. The method may further store the authorization context associated with the resource, and intercept an access request for the resource. The access request may include a second set of access parameters. The method may further check the access request against the authorization context to determine if the second set of access parameters matches the first set of access parameters, and in response to the first set of access parameters matching the second set of access parameters, permit access to the resource in accordance with the second set of access parameters.

### PRIORITY CLAIM

The application claims priority to Provisional Application No. 61/293,158 filed on Jan. 7, 2010, entitled ENFORCEMENT OF POLICIES ON CONTEXT-BASED AUTHORIZATION, which is incorporated by reference in its entirety for any and all purposes.

### RELATED APPLICATION

This application is related to U.S. patent application Ser. No. 12/166,535, attorney docket no. 021756-050200US, entitled USAGE BASED AUTHORIZATION, filed on Jul. 11, 2008, which is incorporated by reference in its entirety for any and all purposes.

### BACKGROUND OF THE INVENTION

Embodiments of the present invention relate generally to methods and systems for authorization and more particularly to enforcing usage/context-based authorization.

Access to and use of resources such as network resources can be controlled in a number of different ways. For example, an Access Control List (ACL) can be used to control access to a resource identified in the list. Generally speaking, the ACL is a list or set of data defining permissions, e.g., read, write, execute, for a user or group of users to access a specific resource. The requesting user is then granted or denied permission to access the requested resource based on the roles or permissions defined for that user or user's group defined in the ACL. In another example, Authentication, Authorization, and Accounting (AAA) systems can be used to authorize a request for a resource. Generally speaking, the AAA system, upon receiving or detecting a request for a resource, can authenticate the requestor (i.e., identify the requestor as who he claims to be) and authorize the request. Again, the requestor is granted or denied permission for the request by mapping the requestor's identify and the requested access to roles and rights defined for the resource.

However, these different approaches to controlling access to a resource have some limitations. For example, while these systems consider the identity of the requestor, the resource or data requested, and the functions to be performed (i.e., read, write, execute), they do not consider a broader context of the request. That is, these systems do not consider such factors as what the requestor plans to do with the data, why the requestor is requesting the operation, under what condition(s) the requestor is making the request, on whose behalf the requestor is making the request, etc. Thus, there are no generic ways to provide authorization of an operation for a particular usage or within a particular context. Hence, there is a need for improved methods and systems for enforcing usage/context-based authorization.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high level, functional components of a system for enforcing an authorization of a request to access a resource according to one embodiment of the present invention.

FIG. 4 is a flowchart illustrating a process for enforcing an authorization of a request to access a resource according to one embodiment of the present invention.

FIG. 5 is a flowchart illustrating a process for enforcing an authorization of a request to access a resource according to an alternative embodiment of the present invention.

FIG. 6 is a flowchart illustrating a process for enforcing an authorization of a request to access a resource including additional details of handling an authorized request according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Methods for enforcing authorization for a request to access a resource are provided in the present invention. More specifically, embodiments of the present invention provide for enforcing the context of an authorization of a request to access a resource. The context can comprise, for example, who made the request, for what purpose or what intended use, what will take place if the request is granted, the identity of another party on behalf of whom the request is made, and other context information such as time of day, location, etc. According to one embodiment, the request can include metadata or other information describing the context or the request. Such information can include, but is not limited to, attribute-value pairs or arguments passed in any desired way such as by reference or by value and defining the context. In some cases, either instead of or in addition to information identifying the context of the request being included in the request, context information can be specifically requested from the requestor, i.e., from the entity requesting to access the resource, or from another component of a set of components and returned in reply to the request for the context. For example, context information can be requested from the original requestor and/or from another process, system, entity, etc. Thus, authorizing a request for a resource can be based on the context information from the request for the resource and/or the context information requested or queried from the requestor or other element of the system. In yet another example, context information can be obtained/provided via a subscribe/notify model. For example, one or more entities can subscribe to context information related to one or more requestors. The context information can be published and/or maintained by the requestor and/or another component or set of components. Upon a change in the context information, the one or more subscribers can be notified of the change. Thus, the system that enforces authorization parameters of the request based on the context has access to the context information and any change therein that may affect the authorization allowing the system to revoke authorization if appropriate.

According to one embodiment, determining if the request for the resource complies with authorization parameters associated with the resource may be accomplished by applying one or more policies to the request and the context of the request. As used herein, a policy can be defined as any logical combination of any condition and any one or more associated actions to be performed upon the satisfaction of the condition. Therefore, policies applied to requests and information defining the context of the request can be defined for enforcing resource constraints of the request based on who makes the request, from where the request is made, for whom the request is made, for what purpose the request is made, etc. as well as what actions are to be taken upon authorization or failure of authorization. Various exemplary methods and systems for applying policies to affect context-based authorization are described in U.S. patent application Ser. No. 10/856,588 filed May 28, 2004 by Maes and entitled “Method and Apparatus for Supporting Service Enablers Via Service Request Composition,” U.S. patent application Ser. No. 10/855,999 filed May 28, 2004 by Maes and entitled “ Method and Apparatus for Supporting Service Enablers Via Service Request Handholding,” U.S. patent application Ser. No. 11/024,160 filed Dec. 27, 2004 by Maes and entitled “Policies as Workflows,” and U.S. patent application Ser. No. 11/565,578 filed Nov. 30, 2006 by Maes and entitled “Orchestration of Policy Engines and Format Technologies” of which the entire disclosure of each is incorporated herein by reference for all purposes.

In a further embodiment, policies are provisioned to restrict authorization (i.e., the policy is defined expressly in terms of what can be done and by whom). Then, when the request is made it is enforced on the request and the response. Further, if the requester (or authorized entity) is on the network, it may also intercept all requests and enforce policies to ensure that the requests comply. For example, a device may be used to implement such restrictions.

In response to determining that the request complies with the access parameters associated with resource, the request can be passed to the resource (or resource provider). In another example, in response to determining that the request complies with the access parameters associated with resource, a response can be returned to the requestor indicating authorization. In some cases, the response can include authorization information such as a token or other signed or encrypted or tamper-proof credential that can be used for accessing the resource. Various additional details of embodiments of the present invention will be described below with reference to the figures.

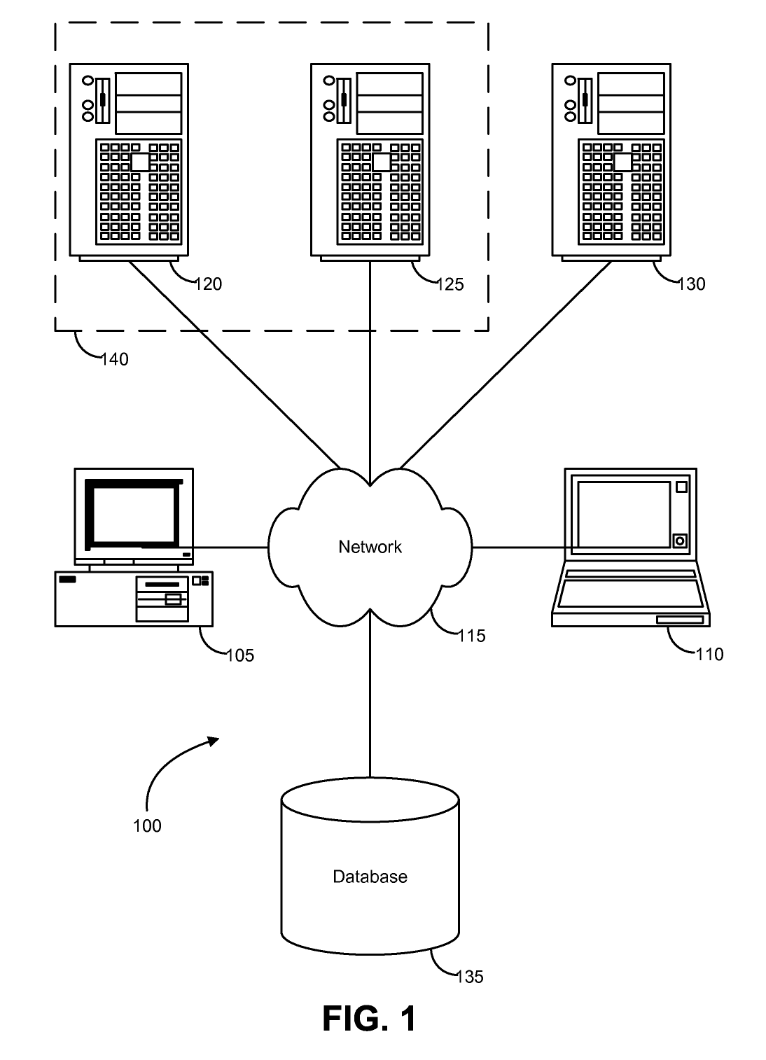

FIG. 1 is a block diagram illustrating components of an exemplary operating environment in which various embodiments of the present invention may be implemented. The system 100 can include one or more user computers 105, 110, which may be used to operate a client, such as a dedicated application, web browser, etc. The user computers 105, 110 can be general purpose personal computers (including, merely by way of example, personal computers and/or laptop computers running various versions of Microsoft® Corp.'s Windows® and/or Apple Corp.'s Macintosh® operating systems) and/or workstation computers running any of a variety of commercially available UNIX or UNIX-like operating systems (including, without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network 115 can be any type of network familiar to those skilled in the art that can support data communications using any of a variety of commercially available protocols, including, without limitation, TCP/IP, SNA, IPX, AppleTalk, and the like. Merely by way of example, the network 115 may be a local area network (“LAN”), such as an Ethernet network, a Token-Ring network and/or the like; a wide-area network (“WAN”); a virtual network, including, without limitation, a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO, etc.

The system 100 may also include one or more server computers 120, 125, 130 which can be general purpose computers and/or specialized server computers (including, merely by way of example, PC servers, UNIX servers, mid-range servers, mainframe computers rack-mounted servers, etc.), personal digital assistants (PDAs), and other such computing devices. One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server 140 can be running an operating system including any of those discussed above, as well as any commercially available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer 105, 110 and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 120, 125, 130. Alternatively, it may be remote from any or all of the computers 105, 110, 120, 125, 130, and/or in communication (e.g., via the network 115) with one or more of these. In a particular set of embodiments, the database 135 may reside in a storage-area network (“SAN”) familiar to those skilled in the art. Similarly, any necessary files for performing the functions attributed to the computers 105, 110, 120, 125, 130 may be stored locally on the respective computer and/or remotely, as appropriate. In one set of embodiments, the database 135 may be a relational database, such as Oracle® 10g, that is adapted to store, update, and retrieve data in response to SQL-formatted commands.

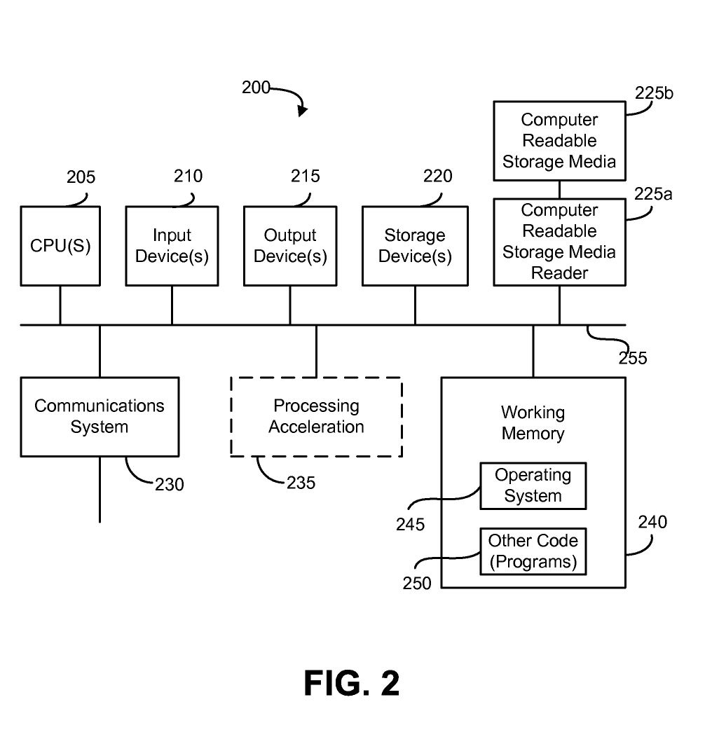

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, a solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 115 (FIG. 1) and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

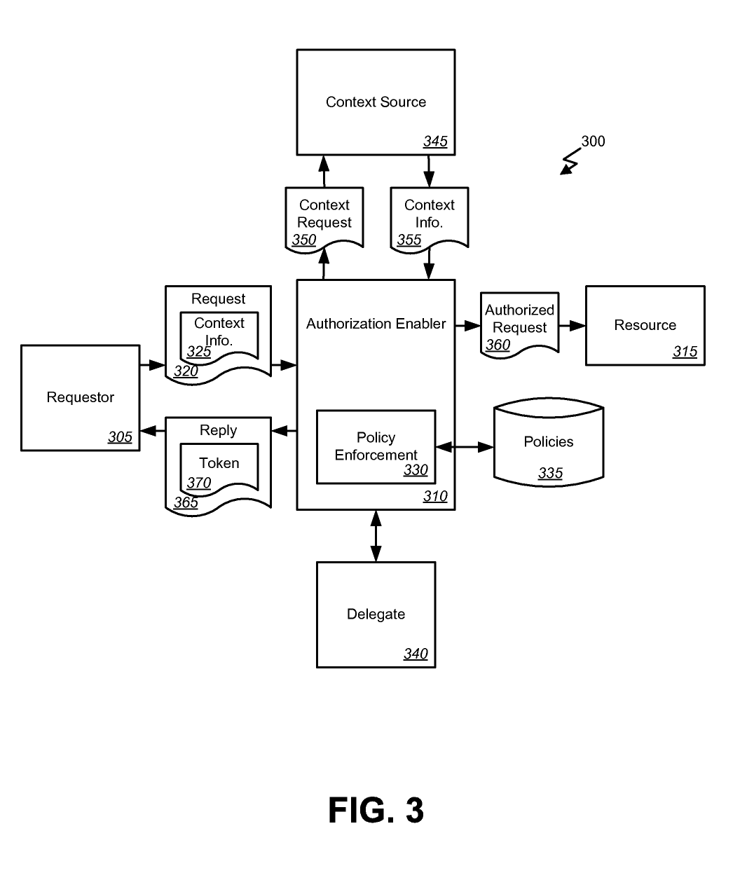

FIG. 3 is a block diagram illustrating, at a high level, functional components of a system for authorizing a request to access a resource and enforcing such authorization according to one embodiment of the present invention. In this example, the system 300 includes a requestor 305, an authorization enabler 310, and a resource 315. The requestor 305 can be communicatively coupled with a network (not shown here) such as the Internet or any other local or wide area network as described above and can comprise any device, system, agent, application, or other entity able to communicate with and access the resource 315. The resource 315 can also be communicatively coupled with the network (not shown here) and can similarly comprise any device, system, agent, application, etc. For example, the resource 315 may comprise a database or other data repository. However, it should be understood that, as used herein, the resource 315 can represent any network resource, element, data, entity, etc. and is not limited to a database or repository.

The authorization enabler 310 can also be communicatively coupled with the network (not shown here) and can receive or detect a request 320 from the requestor 305 to access the resource 315. Alternatively, the authorization enabler 310 can be part of an interceptor in proxy mode that intercepts and then queries the context from the requestor 320 or other component or set of components of the system 300. According to one embodiment, the request 320 can include context information 325 provided by the requestor 305 and defining the context of the request. As noted above, the context information 325 can comprise metadata or other attribute-value pairs, or arguments passed by value or by reference, etc. and defining the context, for example, in terms of who made the request, for what purpose or intended use, what will take place if the request is granted, the identity of another party on behalf of whom the request is made, and other context information such as time of day, location, or any other information. In a further embodiment, requestor 305 and authorization enabler 310 ma be combined into a single entity, or may be separate entities. Furthermore, authorization enable 310 and policy enforcement 330 may occur completely on the requestor-side.

However, the request 320 need not include the context information 325. Rather, the context information 325 may be requested from the requestor 305 or another element of the system 300 by the authorization enabler 310 as needed and provided separately in response to the authorization enabler 310's context request. Furthermore, in addition to or instead of context information 325 provided by the requestor 305, either as part of the request 325 to access the resource 315 or in response to a context request from the authorization enabler 310, context information 355 describing the context of the request 320 can be provided by other elements of the system 300 such as context source 345. That is, one or more context sources 345 can be communicatively coupled with the authorization enabler 310 and can receive a context request 350 from the authorization enabler 310. In response to this request 350 or query, the context source 345 can provide context information 355, e.g., metadata, other attribute value pairs or arguments passed by reference or value, etc., defining the context of the request 320. For example, the context source 345 can comprise a location server that maintains current location information for the requestor 305 and, in response to the context request 350 from the authorization enabler 310, provides context information 355 defining or identifying that current location. It should be understood that, while one context source 345 is illustrated and described here for the sake of simplicity, any number of context sources 345 providing a variety of context information as described herein may be used depending upon the exact implementation of the system 300.

According to one embodiment, context information 325 or 355 can be obtained/provided via a subscribe/notify model. That is, one or more entities can subscribe to context information related to one or more requestors 305. For example, the authorization enabler 310, or resource 315 can subscribe to context information related to requestor 305. The context information can be maintained by the requestor 305 and/or another component or set of components such as the authorization enabler 310 or context source 345. So, for example, the requestor 305 can publish context information to the context source 345 which can in turn maintain the context information. Upon a change in the context information, the context source 345 can notify one or more subscribers, such as the authorization enabler 310, of the change. Thus, the system that authorizes the request, e.g., the authorization enabler 310, based on the context, has access to the context information and any change therein that may affect the authorization allowing the system to revoke authorization if appropriate. In an alternative embodiment, policy enforcement 330 may be implemented separately from authorization enable 310 and further, each may be implemented by separate entities.

Upon receiving the request 320 to access the resource 315 and the context information 325 or 355 defining the context of the request 320, the authorization enabler 310 can determine whether to grant or deny permission to the requestor 305 to access the resource 315. For example, the authorization enabler 310 can include a policy enforcement module 330 adapted to apply one or more policies 335 to the request 320 to access the resource 315 and the metadata 325 and/or 355 defining or describing the context of the request 320. As noted, the policies 335 can comprise logical combinations of conditions and associated actions to be performed upon the satisfaction of the condition(s). Therefore, policies 335 can be defined for determining whether to authorize the request based on who makes the request, from where the request is made, for whom the request is made, for what purpose the request is made, etc. as well as what actions are to be taken upon authorization or failure of authorization.

According to one embodiment, the authorization enabler 310 may delegate some or all of the process of authorizing the request to another element of the system 300. For example, the system 300 can include one or more delegates 340 communicatively coupled with the authorization enabler 310. The delegate 340 can comprise any device, system, agent, application, etc. adapted to perform one or more various authentication functions. For example, the delegate 340 can be adapted to perform authentication, authorization, accounting, or other functions. The functions performed by the delegate 340 can be based on the policies 335. It should be understood that, while one delegate 340 is illustrated and described here for the sake of simplicity, any number of delegates 340 providing a variety of functions may be used depending upon the exact implementation of the system 300.

Upon authorization of the request 320, the authorization enabler 310 can handle the request 320 in a number of different ways. For example, the authorization enabler 320 can pass the authorized request 360 to the resource 315 to allow the requestor 305 to access the resource 315. In other cases, the authorization enabler 310 can perform or request, on behalf of the requestor 305, an action related to the resource 315 and appropriate to the request 320. Alternatively, the authorization enabler 310 can generate and return a reply message 365 to the requestor 305 indicating authorization. In some cases, the reply message 365 can include a token 370 or other credential to then be used by the requestor 305 to access the resource 315. That is, the token 370 can be used by the requestor 305 to directly request access from the resource 315. In doing so, the requestor 305 can provide the token 370 to the resource which in turn permits or denies access based on the token 370. In some cases, the resource may verify the token with the authorization system prior to granting access. It should be understood that, upon failure of authorization, the authorization enabler 310 may return another message (not shown here) to the requestor 305 indicating the denial of permission to access the resource 315. Furthermore, resource 315 (or policy enforcement 330) may query authorization enabler 310 to determine if request 320 was authorized prior to the request or is authorized at the time of request.

According to one embodiment, the requestor 305 may be a trusted entity, a non-trusted entity, a partner entity, etc.; however, even a trusted entity or partner entity may abuse the resource authorization or may be compromised (i.e., hacked, infiltrated, infected by a virus, etc.) into abusing the resource authorization. Hence, enforcement of such authorization may be required or desirable. According to one embodiment, policy enforcement module 330 can provide enforcement of the resource authorization.

In one embodiment, once the requestor 305 has been granted authorization to the resource 315 based on the context information 325, the policy enforcement module 330 may generate the token 370, and transmit the token 370 to the requestor 305. Accordingly, in order to access the resource, the requestor 315 would be required to present the token 370 in order to gain access to the resource 315. Further, policy enforcement 330 may be situated in front of resource 315, and is able to perform the same or similar role. Further, the policy enforcement module 330 can also be in front of the resource and can perform the same role. In addition, the context information 325 would also be provided. Therefore, the policy enforcement module 330 can analyze the token 370 and the context information 325 to determine if the requestor 305's request 320 complies with the restrictions placed on usage of the resource 315.

For example, the requestor 305 may have been authorized to access the resource 315 only to send a short message system (SMS) message and the authorization does not provide any additional authorization. Furthermore, the token 370 presented to the policy enforcement module 330 by the requestor 305 indicates the restricted usage of the resource 315. However, upon receipt of the token 370 and the request 320, policy enforcement module 330 determines that the request 320 includes an SMS message request as well as a global positioning device (GPS) position request. Thus, the requestor 305 has exceeded their authorization of the resource 315, and accordingly, policy enforcement module 330 terminates access to the resource 315 or denies the request 320 by requestor 305. In one embodiment, policy enforcement module may store a copy of the token 370 in the form of a policy stored in policies database 335. In order to verify the proper context and usage of the request 320 and the token 370, policy enforcement module 330 may compare the token stored in the policies database 335 against the token 370 received from the requestor 305. In one embodiment, the token 370 is a way to present or point to credentials for a certain usage. By way of example, token 370 may represent for a way to present or point to credentials for a usage (i.e., not as a mandate for a specific (or existing/future) token technology).

Furthermore, the token 370 (i.e., the token is used to describe or present conditional credentials provided by an authorization system) may include certain restrictions. For example, the token 370 may have a time-out mechanism which only allows the token 370 to be used by requestor 305 for a set period of time (i.e., five hours, two days, two weeks, etc.). In addition, the token 370 may have a number of use restrictions. For example, the token 370 may only be able to be used three times before it is disabled, and then token 370 will no longer be able to be used to provide access to the resource 315. Further, it should be noted that token 370 is a generic term to describe or present a conditional credential frovided by the authorization enabler 310.

Additionally, the token 370 may be examined to determine if it has been tampered with and/or altered, or if the token 370 has been transferred to and used by another requestor. If any of these situations occur, the policy enforcement module 330 can disable the token 370 and deny access to the requestor 305.

In a further alternative embodiment, the policy enforcement module 330 may be implemented on the resource 315. For example, the resource 315 may be a personal digital assistance (PDA), a Smartphone, a portable device, a portable computer, a cellular phone, etc. and requestor 305 may be a service provider. The resource 315 would then be tamper proof, because all enforcement and access are provided from the resource 315's device. Hence, no third party requestor could gain access to the device's resources unless the policy enforcement module 330 running on the device granted access. Furthermore, if the device was tampered with, then the service provider for the device would detect the tampering (i.e., because the service provider has complete access to the device), and then service could be denied to the device.

In one embodiment, the policy enforcement module 330 may be on a device/requester side. In such an embodiment, it may also still have the policy enforcement module 330 in the middle or on resource, but the device side can enforce, for example, that the context or committed authorized usage is respected.

Alternatively, the policy enforcement module 330 may not use a token to enforce the authenticity of the request 320. Instead, the policy enforcement module 330 may store in a database (not shown) a requestor, a context, and a resource table which indicates to the policy enforcement module 330 in what context a requestor is authorized to access a resource. Hence, when the policy enforcement module 330 intercepts the request 320 with the accompanying context information 325, policy enforcement module 330 can check the combination of the requestor 305, the context information 325, and the requested resource 315 against those stored in the database to determine if the requestor 305 is authorized to utilize the resource 315 in the requested context. If the request 320 is proper, then the policy enforcement module 330 may transmit to the requestor 305 the reply 365, or alternatively, if the request 320 is improper, then the policy enforcement module 330 may transmit the reply 365 denying access to the requestor 305.

Furthermore, such information may be passed by reference (e.g., address or pointer) to go get or to query details from the authorization enabler (e.g., by passing a WSDL of interface to query). Also, the authorization enabler, policy enforcement module, token, etc. may support an identity management system, where the identities can be mapped, aggregated, animalized, extend to groups etc.

In a further embodiment, the requestor 305 can be adapted to request 320 access to the resource 315. The authorization enabler 310 can be adapted to receive the request 320 from the requestor 305, identify a context of the request 320, and determine whether to authorize the request 320 based on the context of the request 320. For example, the request 320 can include context information 325 such as metadata or other information describing the context. In such a case, the authorization enabler 310 can be adapted to identify the context-based at least in part on the context information 325 from the request 320. Additionally or alternatively, the authorization enabler 310 can be adapted to request 350 context information describing the context from the requestor 305 or other element of the system 300. In such a case, the authorization enabler 310 can be further adapted to receive the context information 355 in response to the context request 350 and identify the context-based at least in part on the received context information 355.

The authorization enabler 310 can determine whether to authorize the request by applying one or more policies 335 to the request 320 and the context of the request 320. In some cases, the authorization enabler 310 can additionally or alternatively determine whether to authorize the request 320 by delegating at least a part of the determination. In response to determining to authorize the request 320, the authorization enabler 310 can pass the request to the resource 315. In other cases, the authorization enabler 310 can perform or request, on behalf of the requestor 305, an action related to the resource 315 and appropriate to the request 320. Alternatively, in response to determining to authorize the request 320, the authorization enabler 310 can return a response 365 to the requestor 305 indicating authorization. In such a case, the response 365 can include authorization information such as a token 370 or other credential for use in accessing the resource 315.

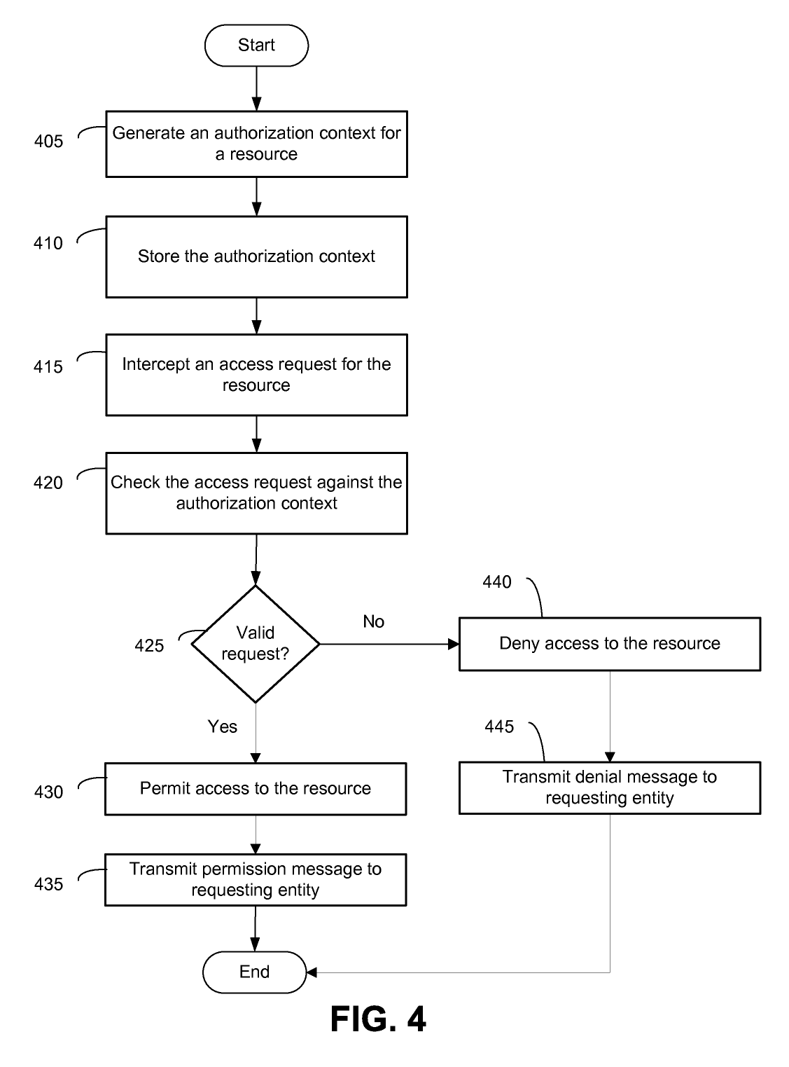

FIG. 4 is a flowchart illustrating a process for enforcing usage/context-based authorization according to one embodiment of the present invention. More specifically, this example illustrates a process that may be performed by the authorization enabler and/or the policy enforcement as described above. In this example, at process block 405 an authorization context for a resource may be generated. For example, a resource may be restricted not only to who can use the resource but how the resource will be used, for how long, etc. Thus, an authorization context may be generated which may include a set of authorized users, a set of authorized uses (i.e., copy, store, read, GPS access, SMS access, presence access, transferability, etc.), as well as any other restrictions and/or limitations of the use of the resource. In other words, a set of access parameters may be generated for each resource.

At process block 410, the authorization context may be stored. In one embodiment, the authorization context may be stored in a database remotely located from the resource, or alternatively the authorization context may be stored locally with the resource. The storage of the authorization context may have restricted access in order to avoid tampering and/or alteration of the various contexts. In addition, each resource may include multiple authorization contexts and some resources may share a context(s).

At process block 415, an access request for the resource may be intercepted. For example, policy enforcement module 330 may intercept the request; however, other entities may intercept the request. In one embodiment, the intercepting entity may have access to the database or other stored mechanism which includes the authorization contexts. Accordingly, the intercepting entity is able to gain access to the database in order to retrieve the authorization context data. Thus, at process block 420, the intercepting entity may check the access request against the stored authorization context.

In one embodiment, accompanying the access request may be an access context or access parameters. For example, the access request may include the accessing entity's identification information, identification of the resource, information about the intended use of the resource, etc. Hence, the intercepting entity can check the stored authentication context against the access parameters supplied with the access request in order to determine if the request is valid (decision block 425).

If it is determined that the access request is valid, then at process block 430 access to the resource may be permitted. Thus, the requesting entity is able to access the resource according to the authorization context associated with the resource. However, the usage may be continuously monitored in order to detect any deviation from the authorization context, and thus, if any deviation occurs, the requesting entity can be denied access to the resource. Furthermore, at process block 435, a message may be transmitted to the requesting entity indicating that access to the resource had been granted.

Alternatively, if at decision block 425 it is determined that the access request is invalid or unauthorized according to the authorization context, then at process block 440 access to the resource will be denied. Such a denial may be due to the requesting entity requesting more access than it is able to or the requesting entity may not be authorized to access the resource at all. For example, if the requesting entity is a service provider, and the resource in which it has authorization to send an SMS to and it instead attempts to send an email, the request would be denied. Similarly, any deviation from the authorization context associated with the resource and the requesting entity would result in a denial of access to the resource. At process block 445, a message indicating the denial may be transmitted to the requesting entity.

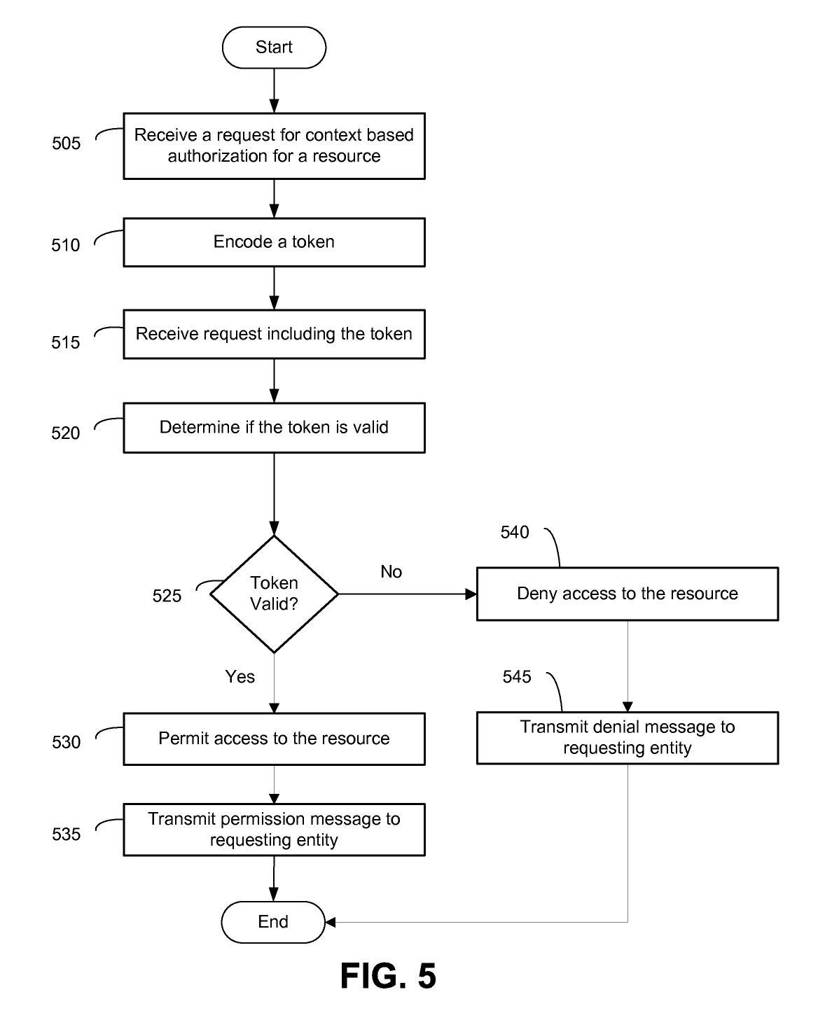

FIG. 5 is a flowchart illustrating a process for encoding and using an authorization token according to an alternative embodiment of the present invention. More specifically, this example illustrates a process that may be performed by the authorization enabler and/or policy enforcement as described above. In the example illustrated in FIG. 5, at process block 505 a request for context-based authorization for a resource may be received. Based on the request, a token may be encoded (process block 510). In one embodiment, the token may be, for example, a key which allows the holder to access the resource. If may also be tied to the requesting entity, and if another entity attempts to use the token, the token may be disabled.

At process block 515, a requesting entity may submit a request to a resource with the accompanying token. Accordingly, the token may then be checked to determine if the token is valid (process block 520). In determining if the token is valid, the policy enforcement may, for example, check the token to make sure that is has not been tampered with or altered. The policy enforcement may also check the requesting entity to verify that the token belongs to the requesting entity.

At decision block 525, a determination is made whether the token is valid. If the token is determined to be valid, then the requesting entity is permitted access to the resource (process block 530). Subsequently, a message may be transmitted to the requesting entity indicating that the entity's token is valid and that its access request to the resource has been granted (process block 535).

Alternatively, if the token is determined to be invalid, then the requesting entity will be denied access to the resource (process block 540). Furthermore, the requesting entity may be restricted from access to any resources until the denial is resolved. Further, at process block 545, a denial message may be transmitted to the requesting entity.

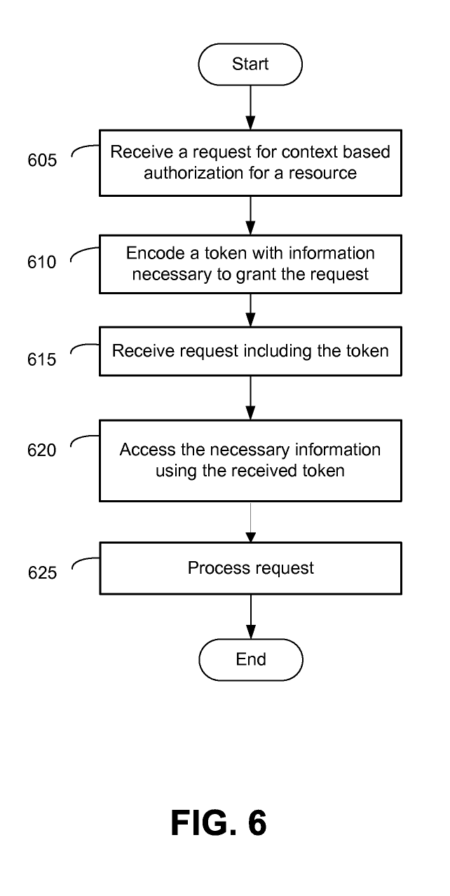

FIG. 6 is a flowchart illustrating an alternative process for encoding and using a token according to one embodiment of the present invention. In this example, at process block 605, a request for context-based authorization for a resource may be received. The request may be, for example, from a service provider (e.g., Google, Yahoo, etc.) to send an SMS message to a cellular device. However, even though the service provider may be a trusted service provider, the policy enforcement may not want to give out the cellular device's address information (i.e., phone number in this case). This may be to protect the cellular device user's privacy because even though the service provider may be trusted now, it may be tempted to send additional SMS messages not related to the authorization context.

Hence, at process block 610, a token may be encoded which includes information necessary for the service provider to be able to send the SMS message, without having the device's address. For example, the token may include a unique identifier which may be used to identify the device, but cannot be used to transmit the SMS message. Accordingly, the service provider could send the SMS message without knowing the device's address.

At process block 615, the SMS message and the corresponding token may be received by, for example, the policy enforcement. The policy enforcement may then, at process block 620, use the token to access the necessary information (i.e., the device's cellular phone number). Further, the request may be processed, or in other words, the SMS message may be sent to the device (process block 625). The SMS message (or any other communication or access to a resource) is able to be sent to the device without divulging the device's address (or any other private information) to the requesting service provider.

In the foregoing description, for the purposes of illustration, methods were described in a particular order. It should be appreciated that, in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine-readable mediums, such as CD-ROMs or other types of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of enforcing usage/context-based authorization, the method comprising:
generating an authorization context for access to a resource, wherein the access includes a first set of access parameters;
storing the authorization context associated with the resource;
intercepting, at a policy enforcer, an access request for the resource, wherein the access request includes a second set of access parameters;
checking, by the policy enforcer, the access request against the authorization context to determine if the second set of access parameters matches the first set of access parameters; and
in response to the first set of access parameters matching the second set of access parameters, permitting access to the resource in accordance with the second set of access parameters.

2. The method of claim 1, further comprising, in response to the first set of access parameters differing from the second set of access parameters, denying access to the resource.

3. The method of claim 1, further comprising based on the authorization request and the first set of access parameters, generating an authorization token.

4. The method of claim 3, further comprising:
sending the authorization token to an entity which generated the authorization request;
presenting the authorization token to the policy enforcer;
checking the authorization token against the access parameters associated with the resource request; and
based on the access parameters conforming with the authorization token, permitting access to the resource.

5. The method of claim 4, wherein the authorization token includes one or more of the following restrictions: a restriction of the number of times usage is permitted, a time-out restriction, and a transfer restriction.

6. The method of claim 5, wherein the token is embedded in the authorization context, and wherein the token is revocable.

7. The method of claim 6, wherein the policy enforcer monitors and reports access to the resource, and wherein the policy enforcer is included in one or more of the following: a device, a requester, a network, middleware, or in front of the resource.

8. The method of claim 7, further comprising based on access violating the context created by authorization token, terminating access to the resource by revoking the token.

9. The method of claim 6, further comprising determining whether the authorization token has been tampered with or altered.

10. The method of claim 9, further comprising, in response to the authorization being tampered with or altered, terminating access to the resource.

11. The method of claim 1, wherein the first set of access parameters provides a context for accessing the resource.

12. The method of claim 11, wherein the access request includes requesting access to the resource in accordance to the context.

13. The method of claim 1, wherein the first and second sets of access parameters include one or more of the following: a file name, a usage of the file, read/write parameters, user account parameters, pointers to interfaces, scripts, workflows, functions, or executables.

14. The method of claim 1, wherein the access request is generated by a third party service provider, and wherein the resource comprises an end-user's device resource and/or service.

15. The method of claim 14, wherein the end-user's device resource and/or service includes one or more of the following: a global positioning system (GPS) resource, a short message system (SMS) resource, an email resource, an application resource, and a voicemail resource.

16. The method of claim 15, wherein the third party service provider is one or more of: a trusted provider, a non-trusted provider, a partner provider, a user, an unknown user, a subscriber, or an enterprise.

17. The method of claim 16, wherein the authorization context includes a combination of resources and/or services which are accessible to the third party service provider.

18. The method of claim 1, further comprising, in response to the second set of access parameters changing, terminating access to the resource.

19. A system enforcing usage based authorization, the system comprising:
a requesting entity configured to request access to a resource, wherein the request includes access parameters; and
an authorization entity coupled with the requestor, the authorization entity configured to receive the request from the requesting entity, identify a context associated with the request, and determine whether to authorize the request based on the context of the request and the access parameters.

20. The system of claim 19, wherein the request includes context information describing the context of the request.

21. The system of claim 20, wherein the authorization entity is further configured to identify the context of the request based at least in part on the context information from the request.

22. The system of claim 19, wherein the authorization entity is further configured to request context information describing the context of the request.

23. A machine-readable medium including sets of instruction for enforcing usage-based authorization which, when executed by a machine, cause the machine to:
receive, from a third party service provider, a request for access to an address of an end-user device;
in response to the request, provide a token to the third party service provider;
receive the token and an accompanying message from the third party service provider;
use the token to determine the address of the end-user device; and
transmit the accompanying message to the end-user device.

24. The machine-readable medium of claim 23, wherein the end-user device is one or more of the following: a personal digital assistant (PDA), a Smartphone, a mobile device, a portable computer, and a cellular phone.
